(19) United States
(12) Patent Application Publication
(10) Pub. No.: US 2012/0001036 A1
(43) Pub. Date: Jan. 5, 2012

(54) Adjustable Refuse Bag Holder

(76) Inventor: Paula Santiago, Plainfield, IL (US)

(21) Appl. No.: 13/173,710

(22) Filed: Jun. 30, 2011

Related U.S. Application Data
(60) Provisional application No. 61/361,518, filed on Jul. 5, 2010.

(51) Int. Cl. B65B 67/12; F16B 2/20

(52) U.S. Cl. 248/101; 248/99

(57) ABSTRACT

A refuse bag holder for holding refuse bags in an upright position comprising an adjustable support frame. The support frame has an upper rim, lower platform, and support columns which extend between and connect the upper rim and the lower platform. The support columns are adjustable telescopically to allow the height of the upper rim to be adjusted. The lower platform is connected to wheels on the back end of the platform, and support legs on the front end. A handle extends from the upper rim to allow the user to push or pull the bag holder. An auxiliary storage unit is connected to the upper rim to provide storage for additional refuse bags, or ties, or other useful items. The upper rim contains securing mechanisms for securing the bag in an open position within the upper rim.

This invention claims the benefit of U.S. Provisional Application No. 61/631,518 filed Jul. 5, 2010.

### FIELD OF THE INVENTION

This invention relates to the field of solutions for holding open refuse bags.

### BACKGROUND OF THE INVENTION

Holding open a refuse bag in an upright position to dispose of refuse such as grass, leaves, or other garden debris, can be difficult when the bag does not maintain an open, upright position for the user to dispose items within the bag. When a refuse bag is filled such that it may maintain an upright position, the contents may spill out when tipped over by wind, or small animals. When the bag is full, the bag may be heavy to carry to a desired location for disposal.

U.S. Pat. Nos. 4,160,557; 4,452,468; 4,917,393; and 4,202,521 disclose various collapsible upright bag holding carts which purport to maintain the bag in an upright position, and allow for subsequent transportation of the bag.

The present inventor has recognized the need for a bag holder which has increased versatility.

The present inventor has recognized the need for a bag holder which allows for more even distribution of weight.

The present inventor has recognized the need for a bag holder which is easier and safer to adjust from a collapsed to an extended position.

### SUMMARY OF THE INVENTION

A refuse bag holder for holding refuse bags in an upright position comprises an adjustable support frame. The support frame comprises an upper rim, lower platform, and support columns which extend between, and connect, the upper rim and the lower platform. The lower platform comprises wheels on one end of the platform, and support legs on end opposite the heels. A handle extends from the upper rim to allow the user to push or pull the bag holder. An auxiliary storage unit is connected to the upper rim to provide storage for additional refuse bags, or ties, or other useful items, The upper rim comprises securing mechanisms for securing the bag in an open position within the upper rim.

In one embodiment, the upper rim and lower platform are rectangular, and supported by four support columns, one at each corner, such that the support frame is in the shape of a rectangular space frame. The support columns are telescopic and comprise concentric segments which move relative to other segments to extend or is compress the length of the support column. Securing mechanisms such as spring clips are disposed on each side of the upper rim, and are oriented to receive the lip of the refuse bag and maintain the refuse bag in an open position. The handle extends from the upper rim and is adjustable in height by adjusting the support columns. The auxiliary storage unit may be disposed on the same side of the upper rim as the handle.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is an exploded view of one exemplary embodiment of the refuse bag holder.

FIG. 2 is a perspective view of an exemplary embodiment of he refuse bag holder in an extended state.

FIG. 3 is a perspective view of the refuse bag holder of FIG. 2 in a collapsed state.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

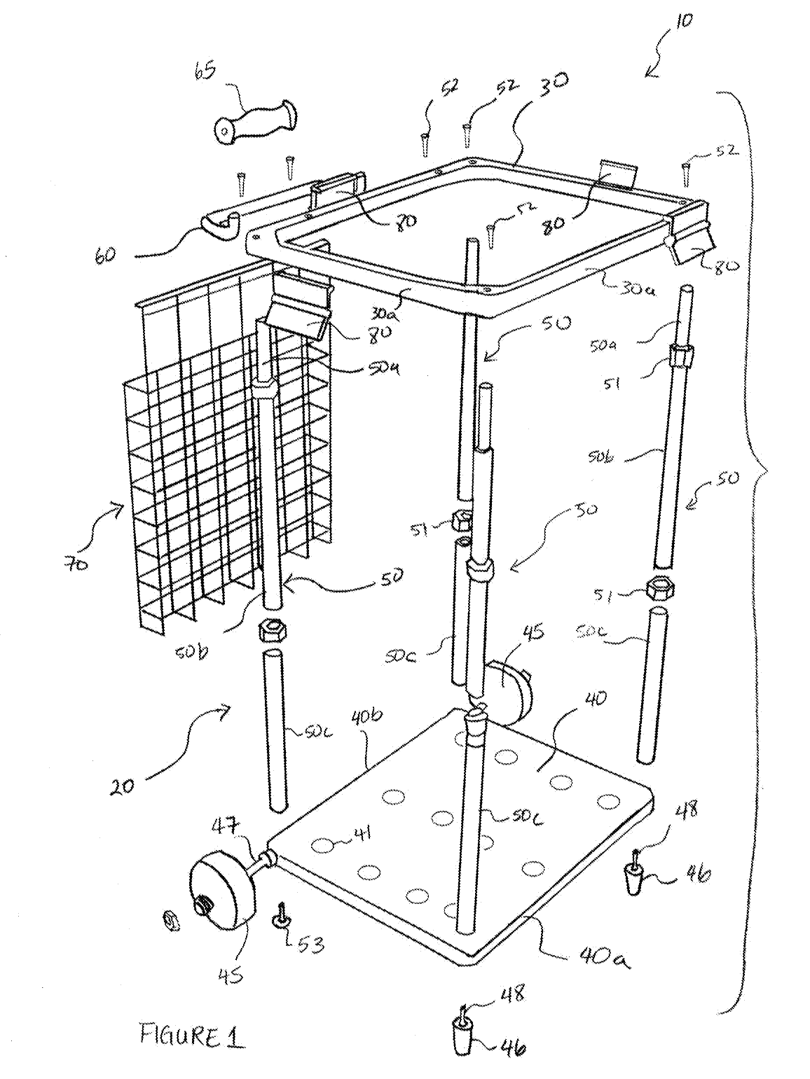

FIG. 1 illustrates an exemplary embodiment of the refuse bag holder. The refuse bag holder 10 comprises a support frame 20 for supporting a refuse bag (not shown) upright and within the area defined by the support frame 20. Support frame 20 comprises an upper rim 30 and a lower platform 40. Upper rim 30 and lower platform 40 are connected by support columns 50 which extend vertically between the upper rim and the lower platform 40, A handle portion 60 extends from the upper rim 30. A handle grip 65 is disposed over a portion of the handle to provide better grasp for the user. As illustrated in FIG. 1, the upper rim 30 is in the shape of a rectangle. Securing mechanisms 80 are disposed on each side of the upper rim 30 for securing a refuse bag to the upper rim 30.

### Support Columns

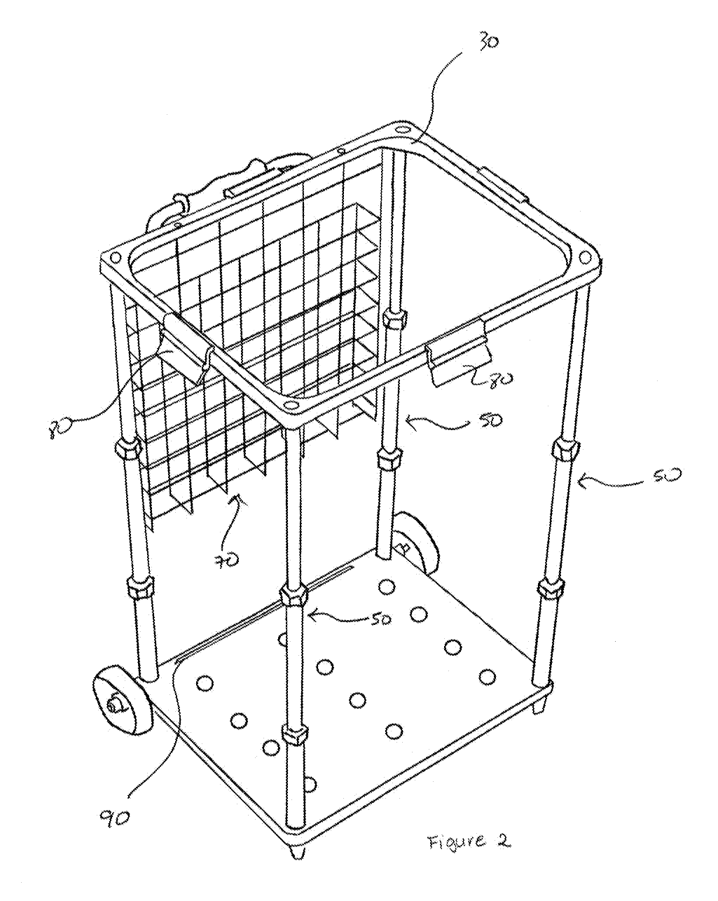

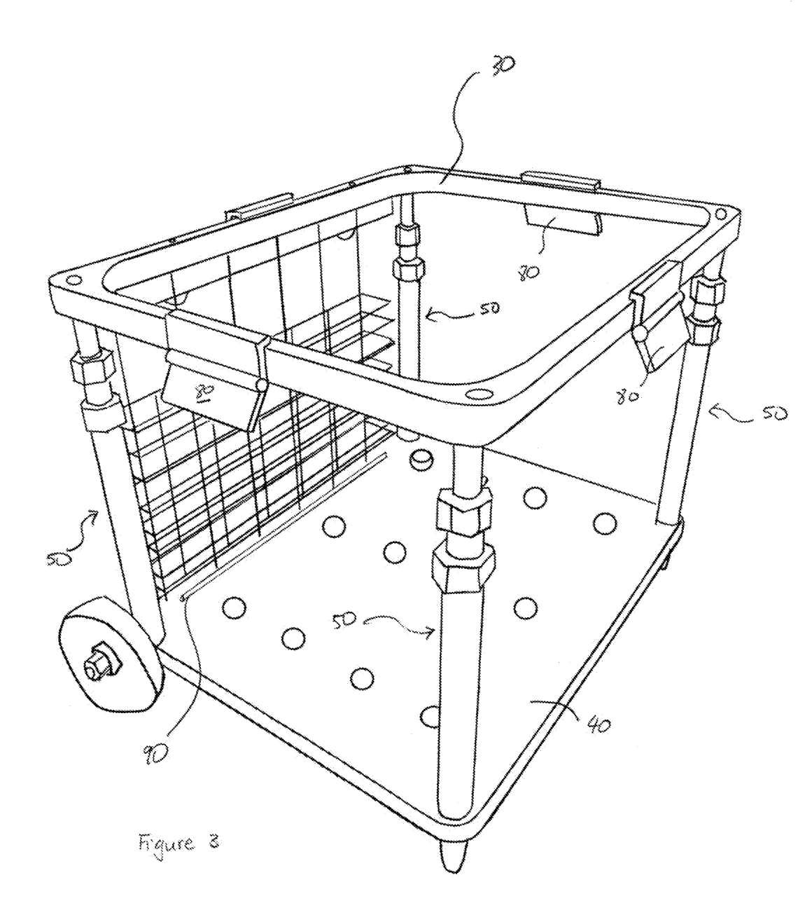

The support columns 50 are adjustable such that distance between the upper rim and the lower platform can be varied. In one embodiment, the adjustable support column ns comprise concentric telescoping segments nested within a larger segment. As illustrated in FIG. 1, the support columns comprise three segments 50a, 50b and 50c which are extended to their desired relative lengths and secured in position with nuts 51. Other methods of providing adjustability to the support columns can also be used, such as providing a ratchet and release mechanism, or a plurality of engagement holes along the segments which can be interlocked with a protrusion into the holes. Any other suitable method for adjusting the height of the support columns can also be used. In one embodiment, the support columns may be extended from a collapsed length of 13.5 inches (33.75 cm) to 35.5 inches (88.75 cm) when extended. In the embodiment is shown in FIG. 1, the support columns are identical. FIG. 2 illustrates one embodiment of the bag holder in an extended state, FIG. 3 illustrates the bag holder of FIG. 2 in the collapsed state.

Support columns and nuts securing the support column segments in the desired position can be made from polypropylene. Other suitable materials can also be used to impart the desired strength and weight characteristics to the support columns, and to the components of the support frame.

### Upper Rim

The upper rim 30 is supported by the support columns 50. The height of the upper rim 30 is adjustable by adjusting the extension of the support columns 50. As illustrated in FIG. 1, the upper rim 30 is rectangular shaped, such as a square. Any other suitable shapes for the upper rim can also be used. In the embodiment shown, the support columns 50 are connected to the upper rim 30 at each of the corners of the upper rim. The support columns may be connected to the upper rim by screws 52, or by any other suitable mechanism such as a friction fitted cavity on the underside of the upper rim, or by any other suitable mechanical engagement. Any number of support columns can be used to support the upper rim.

The corners of the upper rim may be rounded for safety. The upper rim is of a sufficient thickness to allow for securing mechanisms to be disposed along the other surface of the upper rim. The upper rim can be made out of any suitable material, such as a water resistant material and/or a material providing sufficient strength to support a refuse bag with refuse disposed within. The material can comprise materials that are lightweight yet sturdy. In one embodiment the upper rim is made of inflated polypropylene. The upper rim can be any suitable dimension for use with various sizes of refuse bags. In one embodiment the upper rim is 18.5 inches (46.25 cm) long, 15 inches (37.5 cm) wide, with 7/8 inch (2.19 cm) depth and 1⅛ inch (2.81 cm) thickness. A handle portion 60 extends from one side of the upper rim. The handle portion extends in a U-shaped protrusion to allow the user to place their hands around the base of the U. In other embodiments, the handle may be two independent protrusions which extend from the upper rim to allow a user to place a hand around each independent protrusion. Numerous other variations of a suitable handle can also be used. A handle grip 65 disposed about the handle can provide a cushioned support when a user grasps the handle portion 60. The handle can comprise a foamed material such as polyurethane. Other suitable materials such as rubber, silicone, polyvinyl chloride, and the like, and a combination thereof, can also be used.

### Securing Mechanisms

The securing mechanisms 80 are disposed on each side of the upper rim 30 for securing a refuse bag. In one embodiment the securing mechanism is a spring clip which can be opened to receive a portion of the edge of the refuse bag. The spring clip, in its closed position is pressed against the side surface 30a of the upper rim. The spring dip grasps a portion of the edge of the refuse bag to maintain the bag open about the upper rim and to maintain the bag opening at the height of the upper rim. In one embodiment the spring clip comprises two plates which pivot about a hinge. The spring is coiled about the hinge and in its default position presses one plate against the is surface of the upper rim. To open the spring dip to receive a portion of the edge of the refuse bag, a user depresses on the opposite plate to exert a force against the spring.

Any suitable number of securing mechanisms can be used. The number of securing mechanisms can depend on the shape of the upper rim. The securing mechanisms may be disposed near the middle of each side of the rectangular shaped upper rim 30 as illustrated in FIG. 1, or the securing mechanisms may be disposed on the corner. Securing mechanisms can also be disposed on any region of the upper rim. Securing mechanisms also can be disposed on the upper rim such that the position of the securing mechanism can be varied along the upper rim. Securing mechanisms can be evenly spaced apart, or can be disposed as needed to support the weight distribution of the bag depending on the size and shape of the contents.

Other methods of providing a securing mechanism can also be used, such as a fitted rim cover to be disposed over the upper rim. Any other suitable way to maintain the refuse bag in an open and upright position within the upper rim can also be used.

### Auxiliary Storage Unit

In the embodiment illustrated in FIG. 1, an auxiliary storage unit 70 is connected to the upper rim 30 below the handle 60. The auxiliary storage unit 70 can be disposed anywhere along the rim. The auxiliary storage unit 70 can also be secured to the support columns 50 to prevent the auxiliary storage unit 70 from loosely hanging from the upper rim such as when the holder is tilted to move a filled refuse bag to a different location. The auxiliary storage unit 70 may be secured to the upper rim via screw, or may have an upper lip edge which engages with the upper rim such that the auxiliary storage unit can be hung from the rim. Any other suitable method for attaching is or removeably attaching the auxiliary storage unit to the upper rim can be used.

The auxiliary storage unit may be in the form of a basket, such as a basket weaved from polyvinyl chloride cord. The auxiliary storage unit 70 may be made from any suitable material, such as a water resistant and/or flexible material. In other embodiments, the auxiliary storage unit 70 can be an enclosed container such that the contents of the container can be shielded from outdoor elements such as rain, snow, or dirt. The auxiliary storage unit can be any suitable size or shape. For example, the auxiliary storage unit can be a suitable size or shape for holding tools, such as tools related to yard work, or for holding additional refuse bags, and/or ties for the refuse bags.

### Lower Platform

Support columns 50 extend upwards from the lower platform 40, In the embodiment illustrated in FIG. 1, the lower platform 40 is rectangular shaped to correspond with the shape of the upper rim 30. The support columns 50 may be secured to the lower platform 40 via the use of a screw 53, or other mechanical engagement mechanism suitable for securing the support column to the lower platform. The back side 40b of the lower platform comprises a pair of wheels 45 which rotate about an axle 47 journalled through the back side of the lower platform. The front side 40a of the lower platform comprises a pair of leveling supports 46 which allow the front side 40a of the lower platform 40 to be level with the back side 40b of the lower platform. Alternately, the leveling supports may be of a height and/or orientation which results in a front inclination of the lower platform 40 to facilitate the bag dismount by is virtue of gravity.

In other embodiments, the leveling supports 46 may be of a height and/or orientation to allow a backwards inclination to facilitate the user in tilting the refuse bag holder backwards when the bag is full, to transport the bag holder on the back wheels. The wheels may extend from either side of the back side 40b, or the wheels may be disposed below the lower platform, Other suitable arrangements of the wheel can also be used, such as having wheels oriented in a triangular shape, or to correspond with the shape of the lower platform. More or fewer than two wheels can also be used. In one embodiment the wheels are six inches (15 cm) in diameter and the leveling supports are three inches (7.5 cm) in diameter. The wheels and leveling supports can also be any suitable size to provide the desired inclination of the lower platform. The wheels may be made from polypropylene or other suitable material, synthetic or natural, such as rubber. The leveling supports may be made from rubber or other suitable materials, synthetic or natural.

In one embodiment, the leveling supports are secured to the lower platform by a threaded screw 48 which is also used to secure the lower segment 50c of the support column 50 to the lower platform 40.

The backside 40h of the lower platform can comprise a raised ledge 90 (FIGS. 2 and 3) such that when the bag holder is tilted and is supported by the wheels, the bag is prevented from swinging backwards towards the user by the raised ledge.

As illustrated in FIG. 1, the lower platform may be perforated. The perforations 41 can be used to allow any buildup on the lower platform to be removed through the perforations, or can be used to provide a more lightweight lower platform while still is sufficiently supporting the weight of the refuse bag. The perforations 41 can also provide surface traction to minimize movement of the refuse bag on the lower platform. Instead of circular holes, the lower platform may also comprise elongated slots, or comprise of ridges.

The various components of the refuse bag holder can be made from lightweight yet sturdy materials which allow the support frame to maintain its rigidity. The material can be resistant to outdoor elements. The various components such as the lower platform, support columns, upper rim, handle, handle grip, wheels, leveling supports and the auxiliary storage unit can be made of the same or different materials, such as polypropylene, polyethylene, or other synthetic or natural materials.

The dimensions of the bag holder in its expanded state may be able to accommodate standard sized refuse bags which typically measure 16 inches (40 cm) by 12 inches (30 cm) by 35 inches (87.5 cm). The dimensions of the bag holder can also be adjusted to accommodate bags of different sizes and materials. If the bag is shorter in length, the height of the upper rim from the lower platform can be adjusted to lower the upper rim such that the bottom of the bag is supported on the lower platform.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. An adjustable refuse bag holder for holding a bag having an opening, comprising: a height adjustable support frame, said support frame having an upper rim at the top of the support frame, the upper rim having an edge, and the upper rim comprising securing mechanisms for securing the bag opening to the edge of the rim.

2. The bag holder of claim 1 wherein the adjustable support frame comprises a plurality of support columns that support the upper rim.

3. The bag holder of claim 2 wherein the support frame comprises a lower platform and the support columns extend between the lower platform and the upper rim.

4. The bag holder of claim 2 wherein the plurality of support columns comprises concentrically disposed telescoping elements.

5. The bag holder of claim 4 wherein the support columns are secured at their desired extension by tightening nuts.

6. The bag holder of claim 2 wherein the support columns are adjustable using a ratchet mechanism.

7. The bag holder of claim 2 wherein the support columns are adjustable using a mechanical interlocking system.

8. The bag holder of claim 1 wherein the support frame comprises a lower platform located below the upper rim, said lower platform having a front side and a back side; and a pair of wheels disposed in connection with the back side of the lower platform.

9. The bag holder of claim 8 further comprising a pair of level supports on the front side of the lower platform.

10. The bag holder of claim 9 wherein the difference in height from the ground between the wheels and the level support causes the support frame to tilt with a forward inclination.

11. The bag holder of claim 9 wherein the difference in height from the ground between the wheels and the level support causes the support frame to tilt with a backwards inclination.

12. The bag holder of claim 1 further comprising an auxiliary storage unit.

13. The bag holder of claim 1 wherein the securing mechanisms are spring clips.

14. The bag holder of claim 1 wherein the upper rim is rectangular.

15. The bag holder of claim 1 wherein the support frame is a rectangular space frame.

16. The bag holder of claim 1 wherein the securing mechanisms are moveable along the upper rim.

17. An adjustable bag holder comprising:
a support frame having an upper rim and a lower platform connected by adjustable support columns;
a handle portion extending from the upper rim such that an adjustment of the support columns adjusts the height of the handle portion.

18. The bag holder of claim 17 wherein the support columns comprise telescoping segments.

19. The bag holder of claim 17 wherein the upper rim further comprises securing mechanisms for holding a bag in an open position within the upper rim.

20. The bag holder of claim 19 wherein the securing mechanism is a spring clip.
